(19) United States
(12) Patent Application Publication
(10) Pub. No.: US 2022/0090860 A1
(43) Pub. Date: Mar. 24, 2022

(54) KILN STICKER

(71) Applicant: Warren W. WARD, Houston, TX (US)

(72) Inventor: Warren W. WARD, Houston, TX (US)

(21) Appl. No.: 17/029,169

(22) Filed: Sep. 23, 2020

(51) Int. Cl. F26B 25/18

(52) U.S. Cl. CPC F26B 25/185; F26B 2210/16

(57) ABSTRACT

A kiln sticker has an elongated body with the top surface, a bottom surface and a pair of side surfaces extending between the top surface and the bottom surface. The top surface has a first cut-out formed therein which extends for the entire length of the elongated body. The bottom surface has a second cut-out formed therein which extends for the entire length of the elongated body. The first cut-out opens at the top surface. The second cut-out opens at the bottom surface. Each of the pair of side surfaces has a generally V-shaped configuration.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to kilns used for the drying and treatment of lumber and wood. More particularly, the present invention relates to kiln stickers as used for supporting the stacks of lumber or planks within the kiln.

### 2. Description of Related Art Including Information Disclosed Under 37 CFR 1.97 and 37 CFR 1.98

When timber is harvested and hewn into lumber, it is considered green, that is, the lumber has not been conditioned and has a high internal moisture content. Green wood is often not desirable for use in many applications since the lumber will tend to shrink as it dries. This creates gaps or voids when used in construction of structures or objects. Additionally, as the lumber dries, it can warp, split or crack which can weaken or damage the structure or object created using the greenwood. Further, for some applications, the high moisture content of the wood can prevent its use as necessary or desired processes cannot be performed on the wood having a high internal moisture content.

To avoid these potentially negative drawbacks, the wood can be seasoned, allowing internal moisture of the wood to evaporate to a desired or sufficient level for use of the wood or lumber in a desired application. A typical method of seasoning is to leave the cut lumber outdoors, exposed to the elements, so as to allow the internal moisture content of the lumber to equalize with the local environment. Once equalized, the lumber will likely not change dimensionally when used in an application, i.e. the lumber will not warp or contract. To achieve this seasoning, the wood or lumber is left outside to season for an extended period ranging from months to years. As such, large areas needed to store the lumber as it seasons and a seller will have to wait during the seasoning time before selling the lumber.

To speed the process of seasoning, the lumber can be placed in a kiln to dry the lumber to the desired internal moisture content more rapidly. Lumber is placed within the kiln and heated to evaporate the internal moisture, seasoning the wood in a fraction of the time required for passively seasoning the wood or lumber outdoors. Kiln drying lumber can increase the cost of the final product since a larger economic investment is required to purchase and operate the necessary equipment. However, the reduced time to season the lumber and the control of the final moisture content of the lumber have economic benefits that justify the increased costs for the production of the final lumber product.

Traditionally, wood drying operations in wood drying kilns have used utilized wooden kiln stickers normally about three quarters of an inch thick and one and a half inches wide and as long as necessary. The species of wood used for application as stickers varies according to the type of mill and the geographic location. It is desirable to provide a straight kiln sticker and, to do so, knot-free straight green lumber having a large amount of sap would be desired. This type of lumber has the highest raw material cost. Such high-grade lumber is required to resist warpage, twist, compression and deflection of the wood stickers when subjected to the extreme weight and environmental conditions that exist in normal kiln drying operations.

Traditionally, most companies saw their own kiln stickers out of the existing lumber stock. This disrupts the normal production lines due to the changeover for the specific purpose of manufacturing kiln stickers. The kiln stickers in the dry kiln environment are exposed first to extremely wet conditions and then, as the lumber in the kiln is dried, to dry conditions. This combination of wet and dry conditions, plus the weight of the wood in the kiln, reduces the length of the wood kiln sticker and dries the sticker into a set condition. This can result in warpage and compression. When the wood kiln stickers are subjected to subsequent cycles, this warped condition is accentuated and creates jam-ups in the automatic equipment used for loading and unloading the kilns.

Reuse of wood kiln stickers also increases the compression set which occurs on the ends of each sticker and causes “domed” loads which reduce the size of the kiln charge that can be put into the kiln and can cause the kiln charge to overturn and tumble. Further, reuse of wood kiln stickers reduces the efficiency for air passage through the spaces in the lumber load resulting in an increased of drying time to achieve standard dry conditions. Repeated drying cycles using wood kiln stickers eventually degrades the stickers to the point where they must be disposed of, normally in a maximum of five to seven cycles.

FIGS. 1 and 2 illustrate the use of kiln stickers in the prior art. Kiln sticker 10 is used in a conventional way to separate the courses of lumber 12 in the stack 14. The use of stickers that extend across the lumber stack and the stacking of lumber is well-known. The kiln sticker illustrated has a top bearing surface 16. This is designed to engage with the underside of a course of stacked lumber in use. The kiln sticker 10 also has a bottom bearing which has bearing surfaces 18 and 20. These are intended to engage with the top surface of a course of stacked lumber in use.

The transverse extent of the top surface 16 is substantially less than the width of the sticker so that the area of contact between the lumber and the sticker is reduced when compared with conventional sticker designs. A practical width for the sticker across the bottom is one and a half inches. The width of the surface 16 for such a sticker will depend upon the strength of the sticker material, the hardness of the lumber, and the desire to avoid sticker shadow. It should also be wide enough to bear the load.

After the lumber or wood has been dried in the kiln, it will be necessary to move the lumber from the kiln to another location, such as for transport and storage. As such, a pair of conveyors are often employed. One set of the conveyors is employed so as to receive the planks of wood thereon. The second conveyor is utilized so as to receive the discarded kiln stickers (previously located between the courses of lumber). When the kiln stickers are discharged from the main conveyor, they can often become damaged or oriented in an improper direction. As such, as the kiln stickers are conveyed to another location, they must be inspected for quality and orientation. If the kiln stickers have become damaged or warped, it will be necessary to discard such kiln stickers and replace them. As such, a need has developed so as to provide kiln stickers which avoid the need for inspection, orientation and replacement.

In the past, various patents have issued with respect to kilns and kiln stickers used in such kilns. For example, U.S. Pat. No. 3,907,130, issued on Sep. 23, 1975 to D. Hutcheson, describes kiln stickers in the manner shown in FIGS. 1 and 2 hereinbefore. In particular, the kiln sticker has a top bearing and a bottom bearings that engage two space-apart boards of lumber. The transverse extent of the top bearing is substantially less than the width of the sticker.

U.S. Patent Application Publication No. 2016/0290717, published on Oct. 6, 2016 to P. J. Wagner, describe stickers for drying and/or curing materials. The sticker has support members that extend radially outwardly from a central portion. An open-ended channel is configured to allow air flow therethrough. The open-ended channel is defined between each adjacent pair of support members. The central portion of at least a portion of the support members can have a X-shaped cross-sectional shape.

U.S. Patent Application Publication No. 2007/0101608, published on May 10, 2007 to G. Sundholm, discloses an apparatus for the treatment of wood and/or wood products. This apparatus has at least two treating elements between which moist wood or wood products are treated in conjunction with a drying or pressing process. The treating element at least partially consists of a plurality of tubular parts arranged adjacent to each other. A groove is provided between at least some of the adjacent tubular parts.

U.S. Pat. No. 6,134,803, issued Oct. 24, 2000 to Gilchrist et al., discloses a flexible wood sticker. This wood sticker is an elongated four-sided, solid high molecular weight polyethylene wood sticker which serves to separate the lowermost surfaces of uppermost laid-in planking from the uppermost surfaces of lowermost laid-in planking. The flexible wood sticker has four rounded edges marking the intersection of any two sides therein and also has a helically-inclined groove cut into the outer surfaces of all four sides thereof and extends uniformly from one end thereof to the other end thereof.

U.S. Pat. No. 5,813,137, issued on Sep. 29, 1998 to T. M. Townsend, discloses a sticker that is used in the lumber industry to separate pieces of lumber in a stack or in a bundle. The sticker has a plurality of grooves extending transverse to the length of the length of the sticker to permit air circulation within the grooves. There are plurality of ridges between the grooves that support the pieces of lumber.

U.S. Pat. No. 5,345,695, issued on Sep. 13, 1994 to A. B. Graham, discloses a method and apparatus for drying wood. Pieces of wood are stacked in an oven and have a space provided between horizontal layers of the wood so as to permit air flow between the pieces of wood. Channel-shaped, non-moisture absorbing strips of metal or plastic are used for the spacing. The air for drying the wood travels down the channel of the strips to help in the drying of the wood.

U.S. Pat. No. 3,900,957, issued on Aug. 26, 1975 to Denton et al., shows a method and system for drying wood. Courses of wood in the conventional drying kiln are separated by strong, dimensionally stable, re-usable kiln stickers made of paper-reinforced, thermosetting resin laminate having a thickness ranging from one-quarter inch to one inch. The laminate is made by saturating a resin-saturating paper with a thermosetting resin, such as phenol-formaldehyde resin or lignin-phenol-formaldehyde resin.

It is another object of the present invention to provide a kiln sticker that enhances airflow between courses of wood and lumber.

It is another object of the present invention to provide a kiln sticker that is self-righting.

It is another object of the present invention to provide a kiln sticker that is reusable.

It is a further object of the present invention to provide a kiln sticker that avoids sorting and inspection.

It is another object of the present invention to provide a kiln sticker that minimizes contact and shadowing with lumber.

It is another object of the present invention provide a kiln sticker that is strong and durable.

It is a further object of the present invention to provide a kilns sticker that uses less material.

It is a further object of the present invention provide a kiln sticker that enhances the drying of wood.

It is still another object of the present invention provide a kiln sticker that avoids chipping and breaking.

These and other objects and advantages of the present invention will become apparent from a reading of the attached specification and appended claims.

### BRIEF SUMMARY OF THE INVENTION

The present invention is a kiln sticker that comprises an elongated body having a top surface, a bottom surface and a pair of side surfaces extending between the top surface and the bottom surface. The top surface has a first cut-out formed therein. The first cut-out extends for the entire length of the elongated body. The bottom surface has a second cut-out formed therein. The second cut-out also extends for the entire length of the elongated body. The first cut-out opens to the top surface. The second cut-out opens to the bottom surface.

The first cut-out is symmetrical with the second cut-out. The first cut-out has a width at the opening at the top surface that is greater than one half the width of the top surface. The bottom surface has a width at the opening at the bottom surface that is greater than one half the width of the bottom surface. Each of the cut-outs can have a semicircular, semi-oval, semi-elliptical, or parabolic shape.

Each of the pair of side surfaces has a first planar surface extending downwardly from the top surface and a second planar surface extending upwardly from the bottom surface. An end of the first planar surface meets an end of the second planar surface. The first planar surface angles outwardly from the top surface while the second planar surface angles outwardly from the bottom surface. A first chamfer or radius can be formed between the top surface and the first planar surface. A second chamfer or radius can be formed between the bottom surface and the second planar surface.

The top surface defines a first pair of planar shoulders at opposite sides of the first cut-out. The bottom surface defines a second pair of planar shoulders at opposite sides of the second cut-out. A first pair of planar surfaces are co-planar. The second pair of planar surfaces are also coplanar. Each of the pair of side surfaces has a generally V-shaped configuration. The elongated body has a greatest width centrally of the V-shaped configuration of the pair of side surfaces. The elongated body can be formed of a polymer, an elastomer, fiberglass, or wood.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a perspective view of a stack of lumber employing kiln stickers of the prior art.

FIG. 2 is a partial side view of a stack of lumber employing kiln stickers of the prior art.

FIG. 3 is an upper perspective view showing the kiln sticker in accordance with teachings of the present invention.

FIG. 4 is an end view of the kiln sticker in accordance with the teachings of the present invention.

FIG. 5 is an end view of an alternative embodiment of the kiln sticker of the present invention.

FIG. 6 is an end view of still another alternative embodiment of the present invention.

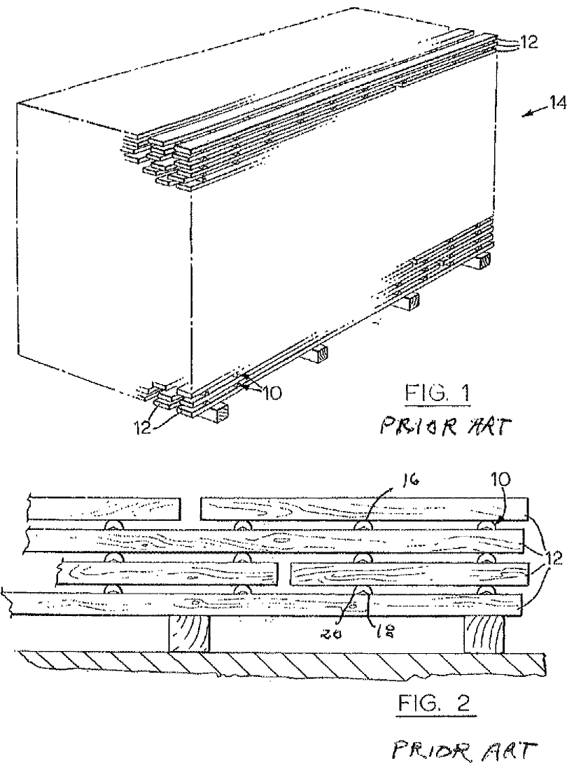

### DETAILED DESCRIPTION OF THE INVENTION

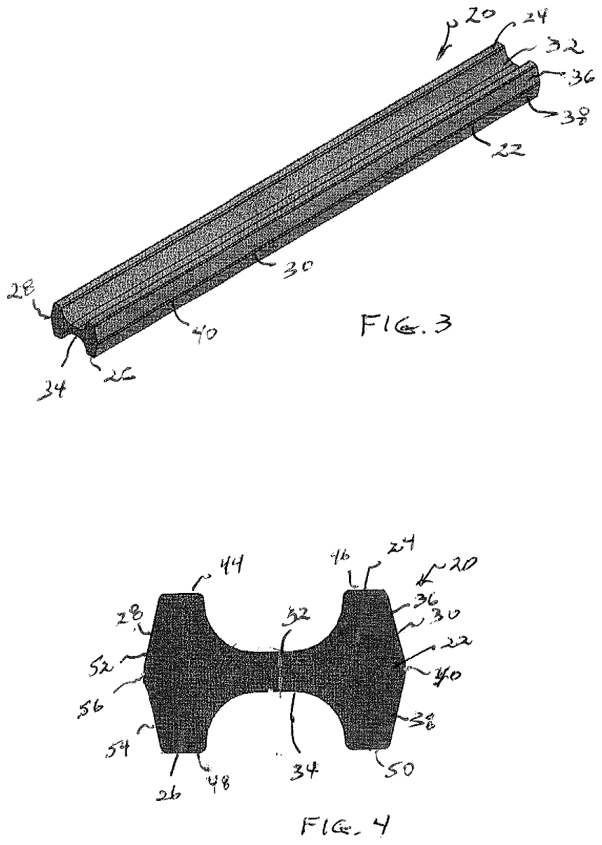

Referring to FIG. 3, there is shown the kiln sticker 20 in accordance with the preferred embodiment of the present invention. The kiln sticker 20 has an elongated body 22 with a top surface 24 and a bottom surface 26. A pair of side surfaces 28 and 30 extend between the top surface 24 and the bottom surface 26. The top surface 24 has a first cut-out 32 formed therein. This first cut-out 32 extends for the entire length of the elongated body 22. The bottom surface 26 has a second cut-out 34 formed therein. The second cut-out 34 also extends for the entire length of the elongated body 22. It can be seen that the first cut-out 32 opens at the top surface 24. Similarly, the second cut-out 34 opens at the bottom surface 26.

The first cut-out 32 will be symmetrical with the second cut-out 34. The first cut-out 32 has a width dimension at the location where the first cut-out 32 opens at the top surface 24. The width of the first cut-out is greater than one-half the entire width of the top surface 24 between side surfaces 28 and 30. Similarly, the second cut-out 34 will have a width dimension at the opening at the bottom surface 26. Once again, this width dimension of the second cut-out 34 will be greater than one-half the entire width of the bottom surface 26 as measured between side surfaces 28 and 30. It can be seen that the cut-outs 32 and 34 can be semi-circular, semi-oval, semi-elliptical, or parabolic.

The side surface 30 has a first planar surface 36 extending downwardly from the top surface 24. Side surface 30 also has a second planar surface 38 extending upwardly from the bottom surface 26. The first planar surface 36 and the second planar surface 38 will have an end meeting at line 40. Line 40 is central of the side surface 30. Side surface 28 will have a similar configuration to that of side surface 30. It can be seen that the first planar surface 36 angles outwardly and downwardly from the top surface 24. Similarly, the second planar surface 38 angles upwardly and outwardly from the bottom surface 26. The first planar surface 36 and the second planar surface 38 have a V-shaped configuration. The width of the elongated body 28 is greatest at the center of the side surfaces 22 and 30 (i.e., out at line 40).

As can be seen in FIG. 4, the corners of the kiln sticker 20 are suitably radiused. This radiusing enhances the “self-righting” capability of the present invention. As such, for example, there is a small radius between top surface 24 and the side surfaces 28 and 30. Similarly, there a radius formed between the bottom surface 26 and the side surfaces 28 and 30. Additional radiusing can occur in the areas at which the first cut-out 32 and the second cut-out 34 open at the respective top surface 24 and bottom surface 26.

The elongated body 22 is be preferably formed of fiberglass. However, the elongated body 22 can also be formed of a polymer, an elastomer or wood. Additionally, so as to reduce cost, the elongated body 22 can be formed from recycled plastics. Ultimately, the material used for the elongated body should be able to withstand the temperatures associated with a wood drying and curing kiln. The elongated body 22 can be easily formed through an extrusion or pultrusion process. It is only necessary to extrude the symmetrical shape of the elongated body and cut the extruded material into desired lengths.

The kiln sticker 20 of the present invention has a number of unique advantages. First, each of the top surface 24 and the bottom surface 26 will minimally contact the uppermost wood panel and the lowermost wood panel between which the kiln sticker 20 is placed. As such, this effectively minimizes any “shadowing” of the wood placed upon the surfaces. The use of the cut-outs 32 and 34 facilitates the airflow and enhances the drying of wood. Since the kiln sticker 20 is formed of a synthetic material, and not formed of wood, it will become extremely difficult to damage. As such, the kiln sticker 20 can be repeatedly reused throughout the wood drying and curing processes. An important feature the present invention is the unique V-shaped configuration of the side surfaces 28 and 30. No matter how the kiln sticker 20 may land after being discharged by a conveyor belt, the V-shaped side surfaces will create a “self-righting” effect. As such, if the kiln sticker 20 should land the one of the side surfaces, the angling of the side surfaces will cause the kiln sticker to tip over to the proper orientation, such as illustrated in FIG. 3.

The use of synthetic material, such as recycled plastic, greatly reduces the cost associated with the kiln sticker 20. Since the kiln sticker 20 is formed of a synthetic material, it will not warp, break or become damaged after repeated reuse. As such, the present invention avoids the need to replace damaged kiln stickers. Since the kiln sticker 20 is formed of a synthetic material, there is no need for continual inspection and replacement of such kiln stickers.

FIG. 4 is an end view of the kiln sticker 20 of FIG. 3. As can be seen, the kiln sticker 20 has an elongated body 22 with a top surface 24 and a bottom surface 26. The first cut-out 32 is formed in the top surface 24. The second cut-out 34 is formed in the bottom surface 26. The top cut-out 32 opens at the top surface 24. The bottom cut-out 34 opens at the bottom surface 26. FIG. 4 clearly shows that the first cut-out 32 has a width dimension that is greater than one half of the width dimension of the top surface 24 as measured between side surfaces 28 and 30. Similarly, the second cut-out 34 will also have a width at the opening at the top surface 26 that is greater than one half of the width of the bottom surface 26 between the sides 28 and 30.

The top surface 24 defines a pair of planar shoulders 44 and 46. This pair of planar shoulders 44 and 46 are on opposite sides of the first cut-out 32. The bottom surface 26 defines another pair of planar shoulders 48 and 50 on opposite sides of the second cut-out 34. Planar shoulders 44 and 46 are coplanar. Similarly, planar shoulders 48 and 50 are coplanar. The planar shoulders 44, 46, 48 and 50 can have a peel ply surface thereon. As such, this provides an anti-slip feature to the kiln sticker 20 of the present invention. The planar surfaces on the side surfaces 28 and 30 would not have such an anti-slip feature since it is desirable for the side surfaces to gravitate toward the position wherein the shoulders 44 and 46 are at the top and shoulders 48 and 50 are at the bottom. This peel ply surface should have a certain degree of tackiness so as to be easily separable from the overlying an underlying courses of wood.

Side surface 28 has a first planar surface 52 and a second planar surface 54 which meet at line 56. The first planar surface 52 angles downwardly and outwardly from the first planar shoulder 44 of top surface 24. The second planar surface 54 angles upwardly and outwardly from the first planar shoulder 48 of the bottom surface 26. The ends of the planar surfaces 52 and 54 will meet at line 56. As was described hereinabove, the second side surface 30 has a first planar surface 36 and a second planar surface 38. The first planar surface 36 angles downwardly and outwardly from the second planar shoulder 46 of top surface 24. The second planar surface 38 angles upwardly and outwardly from the second planar shoulder of bottom surface 26. Ultimately, the planar surfaces 36 and 38 will meet at line 40.

The planar surfaces 36, 38, 52 and 54 will extend and angle with respect to horizontal. In the preferred embodiment of the present invention, this angle can be 76°, 78°, 80° or 82°. However, within the concept of the present invention, these angled planar surfaces can be arranged at various other angles.

FIG. 4 shows that the kiln sticker 20 has a very symmetrical shape. As such, users do not have to properly orient the kiln sticker 20. Since the kiln sticker 20 has the “self-righting” characteristic achieved by the V-shaped side surfaces, the kiln sticker 20 will have identical surfaces facing upwardly and downwardly.

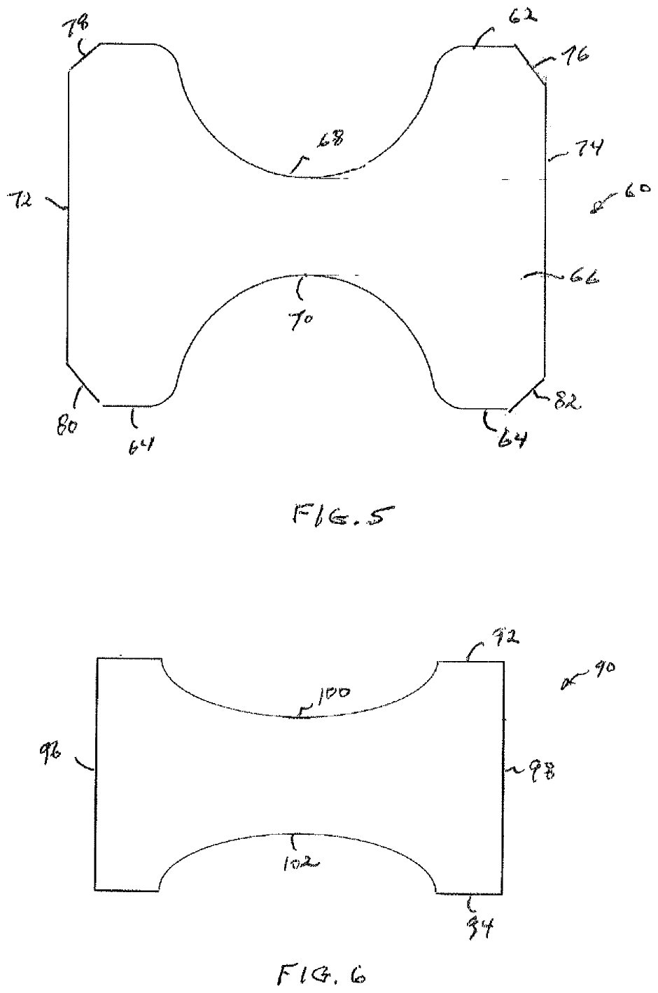

FIG. 5 shows an alternative embodiment of the kiln sticker 60 of the present invention. Kiln sticker 60 has a configuration similar to that of the previous embodiment. In particular, kiln sticker 60 has a top surface 62 and a bottom surface 64 of elongated body 66. A first cut-out 68 is formed in the top surface 62. A second cut-out 70 is formed in the bottom surface 64. Cut-outs 68 and 70 will be similar to cut-outs 32 and 34 of the previous embodiment. A side surface 72 will extend between the top surface 62 and the bottom surface 64. Side surface 74 will also extend between the top surface 62 and the bottom surface 64.

In FIG. 5, it can be seen that there is a chamfer 76 that extends between the top surface 62 and the side surface 74. Another chamfer 78 extends between top surface 62 and side surface 72. Chamfer 80 extends between bottom surface 64 and side surface 62. Chamfer 82 extends between bottom surface 64 and side surface 74. This chamfer can be used so as to further enhance the self-righting characteristic of the present invention.

In FIG. 5, it can be seen that side surfaces 72 and 74 are straight and not V-shaped. As such, the kiln sticker 60 achieves the previous advantages of the kiln sticker 20 but does not have the same “self-righting” capability. The use of the chamfers 76, 78, 80 and 82 further serves to minimize any contacts between the top surface 62 and the bottom surface 64 with adjacent pieces of lumber.

FIG. 6 shows a very simple embodiment of the kiln sticker 90 of the present invention. Kiln sticker 90 includes a top surface 92 and a bottom surface 94 along with side surfaces 96 and 98 extending between the top surface 92 and the bottom surface 94. Cut-outs 100 and 102 are formed respectively in the top surface 92 and the bottom surface 94. The cut-outs 100 and 102 have a generally semi-elliptical or parabolic shape. The cut-outs 100 and 102 are symmetrical to each other. Although the kiln sticker 90 will achieve many of the advantages of the preferred embodiment the present invention (as illustrated in FIGS. 3 and 4), it will have less of a self-righting feature. Since the kiln sticker 90 is symmetrical, it will not matter which side is up or down. However, since the side surfaces 96 and 98 are flat, it may be necessary to tip the kiln sticker 90 in order to achieve its desired orientation.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A kiln sticker comprising:
an elongated body having a top surface and a bottom surface and a pair of side surfaces extending between the top surface and the bottom surface, the top surface having a first cut-out formed therein, the first cut-out extending for an entire length of said elongated body, the bottom surface having a second cut-out formed therein, the second cut-out extending for the entire length of said elongated body, the first cut-out opening at the top surface, the second cut-out opening at the bottom surface.

2. The kiln sticker of claim 1, wherein the first cut-out is symmetrical to the second cut-out.

3. The kiln sticker of claim 1, the top surface having a width, the first cut-out having a width at the opening at the top surface that is greater than one-half the width of the top surface, the bottom surface having a width, the second cut-out having a width at the opening at the bottom surface that is greater than one half the width of the bottom surface.

4. The kiln sticker of claim 1, the first cut-out and the second cut-out having a shaped selected from the group consisting of semi-circular, semi-oval, semi-elliptical, and parabolic.

5. The kiln sticker claim 1, each of the pair of side surfaces comprising:
a first planar surface extending downwardly from the top surface; and
a second planar surface extending upwardly from the bottom surface, an end of the first planar surface meeting at an end of the second planar surface.

6. The kiln sticker of claim 5, the first planar surface angling outwardly from the top surface, the second planar surface angling outwardly from the bottom surface.

7. The kiln sticker of claim 5, further comprising:
a first chamfer or radius formed between the top surface and the first planar surface; and
a second chamfer or radius formed between the bottom surface and the second planar surface.

8. The kiln sticker of claim 1, the top surface defining a first pair of planar shoulders at opposite sides of the first cut-out, the bottom surface defining a second pair of planar shoulders at opposite sides of the second cut-out.

9. The kiln sticker of claim 8, the first pair of planar shoulders being coplanar, the second pair of planar shoulders being coplanar.

10. The kiln sticker of claim 1, each of the pair of side surfaces having a generally V-shaped configuration, said elongated body having a greatest width centrally of the V-shaped configuration of the pair of side surfaces.

11. The kiln sticker claim 1, said elongated body being formed of a material selected from the group consisting of a polymer, an elastomer, fiberglass or wood.

12. A kiln sticker comprising:
an elongated body having a top surface and a bottom surface and a pair of side surfaces extending between the top surface and the bottom surface, each of the pair of side surfaces comprising:
a first planar surface extending downwardly from the top surface; and
a second planar surface extending upwardly from the bottom surface, an end of the first planar surface meeting an end of the second planar surface.

13. The kiln sticker of claim 12, the first planar surface angling outwardly from the top surface, the second planar surface angling outwardly from the bottom surface.

14. The kiln sticker of claim 12, further comprising:
a first chamfer or radius formed between the top surface and the first planar surface; and
a second chamfer or radius formed between the bottom surface and the second planar surface.

15. The kiln sticker of claim 12, each of the pair of side surfaces having a generally V-shaped configuration, said elongated body having a greatest width centrally of the V-shaped configuration of the pair of side surfaces.

16. The kiln sticker of claim 12, the top surface having a first cut-out formed therein, the first cut-out extending for an entire length of said elongated body, the bottom surface having a second cut-out formed therein, the second cut-out extending for the entire length of said elongated body, the first cut-out opening at the top surface, the second cut-out opening at the bottom surface.

17. The kiln sticker of claim 16, the first cut-out being symmetrical to the second cut-out.

18. The kiln sticker of claim 16, the top surface having a width dimension, the first cut-out having a width at the opening of the top surface that is greater than one-half the width dimension of the top surface, the bottom surface having a width dimension, the second cut-out having a width at the opening of the bottom surface that is greater then one half the width dimension of the bottom surface.

19. The kiln sticker of claim 16, wherein the top surface defines a first pair of planar shoulders at opposite sides of the first cut-out, the bottom surface defining the second pair of planar shoulders at opposite sides of the second cut-out, the first pair of planar shoulders being co-planar, the second pair of planar shoulders being co-planar.

20. The kiln sticker of claim 12, said elongated body being formed of a material selected from the group consisting of a polymer, an elastomer, fiberglass, and wood.
